(19) United States
(12) Patent Application Publication
(10) Pub. No.: US 2023/0362009 A1
(43) Pub. Date: Nov. 9, 2023

(54) USER IDENTIFICATION AND AUTHENTICATION METHOD AND SYSTEM

(71) Applicants: John Charles Schwinn, Myrtle Beach, SC (US); Edgard Pereira, Sao Paulo (BR); Marcelo Rosa, Campinas (BR)

(72) Inventors: John Charles Schwinn, Myrtle Beach, SC (US); Edgard Pereira, Sao Paulo (BR); Marcelo Rosa, Campinas (BR)

(21) Appl. No.: 17/662,017

(22) Filed: May 4, 2022

(51) Int. Cl. H04L 9/32

(52) U.S. Cl. CPC H04L 9/3236

(57) ABSTRACT

A system and method to determine and authenticate the identity of a user by comparing the results of calculations performed by two or more independent computing devices, each using different inputs and algorithms in said calculations, and without comparing said user's submission or credential to any data or information known to be related to the subject user and previously stored by the system.

### FIELD OF INVENTION

This invention relates to a system and method to be used to determine and authenticate the identity of a specific individual person or item (individually or collectively herein referred to as a “user”), where an item might be for example without limitation, a computer, a communications participant or device, a device on the internet of things (IoT), or a piece of data, that (i) dynamically generates, encrypts, and transmits a data hash (the “user data hash”) to a central authenticating resource or server or to a related resource or server (the “central server”), where said user data hash does not contain and, when decrypted by the central server, does not resolve directly or indirectly into any previously stored data or information that is known to be related to the subject user; (ii) does not identify or authenticate a subject user by comparing the user data hash to any previously stored data or information known to be related to the subject user, and; (iii) identifies and authenticates a subject user by analyzing the results of certain calculations performed asynchronously by the user device and the central server, where said calculations do not use identical inputs or algorithms. When used herein, the term “previously stored data or information” shall be defined as any data or information that is stored on the central server prior to receipt by the central server of a subject user data hash. More specifically, this invention relates to a system and method, as described above, that (i) identifies a user attempting to access a restricted resource or in certain financial, communications, or other transactions, whether on the Internet, a computer network, phone, through a call center, via email, or in person; (ii) increases the security of certain financial, communications, or other transactions, whether on the Internet, a computer network, phone, through a call center, via email, or in person; (iii) eliminates the need for username, password, and any other static credential in certain financial, communications, or other transactions, whether on the Internet, a computer network, phone, through a call center, via email, or in person, and; (iv) identifies and authenticates the user when a commercial participant and a subject user are first establishing a relationship, known without limitation as “user onboarding,” whether on the Internet, a computer network, phone, through a call center, via email, or in person. Examples of such onboarding transactions include without limitation a person applying for a credit card, mortgage or other loan, or opening a bank or brokerage account.

### BACKGROUND OF THE INVENTION

Identity fraud is a major and growing concern for both commercial participants and consumers in financial and other transactions. Identity fraud occurs in virtual transactions, such as a user logging into a secure website or making a purchase on the Internet, and physical transactions, such as a consumer using a payment card at a local store. It is estimated that over 80% of all identity theft is a result of stolen or weak passwords. It is further estimated that between 2008 and 2020, over 11 billion electronic records were stolen and that in 2020, identity theft increased by over 45% and cost US businesses and individuals over $56 billion.

Prior to the subject invention, all identification and authentication methods known to the inventor authenticate a subject user by decrypting a submitted credential and comparing it to data or information known to be related to the subject user that has been previously stored on a central server. Examples of credentials include without limitation, reusable usernames, reusable passwords or PINs, single use passwords or codes transmitted to a known user during an authentication process through the same or a separate electronic channel, and biometric characteristics of the subject user. These previously stored static pieces of information, or “shared secrets,” are sensitive and highly valuable since, if stolen or intercepted, they grant a bad actor access to a restricted resource, a payment card, or financial or other account of the subject user.

In all prior art known to the inventor, a subject user inputs and transmits one or more shared secrets during the identification and authentication process. The subject user does this directly, such as entering a username and password, or indirectly, such as (i) scanning a fingerprint that is converted into the shared secret by the user device and transmitted to the central server, or; (ii) logging into a mobile app with a locally stored password and then the mobile device transmits a previously stored credential known to be related to the user to a web or application server. The offered credential is decrypted and compared to the known shared secret by an authenticating server and if there is no match, the user is rejected; if there is a match, the user is authenticated, or, as is increasingly common today, is passed to a multi-factor authentication (MFA) process. The most common MFA process used today is a combination of a pre-existing repeat-use username/password pair and a one-time code, generated dynamically and sent by the commercial participant or its designee to the user through a separate electronic channel during the authentication process. The user then receives, inputs, and transmits this one-time code to the commercial participant through the original channel. The one-time code is decrypted and compared to the known code and the process is completed. It is important to note, though, that even this dynamically generated one-time code or password is a pre-existing shared secret prior to its use by the user in the authentication process, in that it was generated and known to the commercial participant as related to the subject user, then transmitted to the user, then known and transmitted by the user back to the commercial participant, who then decrypts it and compares it to the previously stored and known shared secret. This process does not eliminate the risk of the use of credentials that include shared secrets that are compared to previously stored data stored on a central server, it simply reduces the amount of time a bad actor has to steal and use the relevant data or information. Thus, the process remains vulnerable to theft or disclosure. Most commonly, the one-time code is sent via SMS text and can be obtained by bad actors through methods such as SIM swap or certain social engineering hacks.

The inventor believes that the core weakness of all previous authentication methods known to the inventor is that the submitted credential, when decrypted, resolves to a previously stored data element or piece of information that is known to be related to the user. This shared secret is vulnerable to theft, disclosure, and misuse—as noted above, stolen or weak passwords are the root cause of over 80% of all identity theft, which costs the US economy over $56 billion annually. The subject invention eliminates this weakness.

A related but separate process is that of establishing and authenticating a user's identity when a commercial participant and a user are first establishing their relationship, known without limitation as “user onboarding.” Example transactions include without limitation, a user applying for a credit card, mortgage or other loan, or opening a bank or brokerage account. Commercial participants use various costly means to identify and authenticate users in these transactions, including without limitation, digital review of official identification documents (such as scanned driver's license or passport), user challenge and response with questions about the user's personal or credit history developed from public or proprietary sources, and user verification of micro-charges to other known user accounts. These methods are vulnerable to fraud, expensive to maintain and protect against bad actors, burdensome to the user, and in some cases extremely time consuming. Further, the process is inherently inefficient. A given individual must be authenticated multiple times; at least once by each commercial participant with which he or she has a relationship, because given current industry practices, the risk of an incorrect authentication is too high for any commercial participant to rely upon an earlier authentication made by another commercial participant. For example, according to IBM, in 2019 the average time to identify and contain a data breach was 279 days. Couple this with Statistica's 2022 findings that from 2017 to 2020, on average nearly 250 million records were stolen annually, and it is clear that no commercial participant can rely upon another's authentication when that authentication relies upon comparing a submitted credential to a centrally stored database of data and information known to be related to specific users. The subject invention eliminates this risk and enables an entirely new, more secure, and efficient process.

### SUMMARY OF INVENTION

In various exemplary embodiments, the subject invention comprises a system and method to identify and authenticate a specific individual person or item during various transactions on the Internet, a computer network, on the phone, through a call center, in person, or via email. The subject invention represents a complete change from existing commercial practice in the prior art, as described above, in part due to five defining characteristics. Specifically, the subject invention has the following characteristics: (i) for every transaction, it dynamically generates and transmits a “user data hash” that does not contain, refer to, or when decrypted by a central server, resolve directly or indirectly into any previously stored data or information known to be related to the subject user; (ii) upon receipt of the user data hash, the central server does not compare it, in an encrypted decrypted, modified, or manipulated state, to any previously stored data or information known to be related to the subject user; (iii) upon receipt of the user data hash, the subject invention independently generates a “server data hash,” without reference to the user data hash, using data inputs and an algorithm that (a) are different from those used to generate the user data hash, and (b) are stored only on the central server and not on the subject user device or on any other server or resource, (iv) the server data hash does not contain, refer to, or when decrypted, resolve directly or indirectly into any previously stored data or information known to be related to the subject user, and; (v) the system then compares the user data hash to the server data hash to ascertain whether it can determine and authenticate the identity of a given subject user. The system can be used when identifying and authenticating a specific individual person or item in restricted resource access, financial, communications, email, onboarding, or certain other transactions, regardless of whether the transaction is on the Internet, a computer network, phone, through a call center, via email, or in person.

For background purposes, “hash” is a standard technical term and process and as used herein refers to an encrypted output of a fixed length, generated using an algorithm and various data inputs. Any hash generated or used in the subject invention cannot be used to “reverse-engineer” the original input or inputs, since the hash functions are “one-way.”

The central server does not store or have access to the user device algorithm or to the original data inputs used to generate the user data hash nor, prior to transmission, to the user data hash itself. Likewise, the user device does not store or have access to the server device algorithm or to the original data inputs used to generate the server data hash. When the hash from a subject user is received, the central server has no previously stored data or information to compare it to for purposes of identification or authentication. In all embodiments, the subject invention (i) generates and utilizes a user data hash and server data hash that do not contain any sensitive or re-usable information; (ii) delivers multi-factor authentication of the subject user in a given transaction in that during the identification and authentication process, multiple electronic channels are utilized, and; (iii) identifies and authenticates not only the user, but also the web or application server, as appropriate, of the commercial participant associated with the system process, and the central server.

In one embodiment, when integrated with a given website or page on the Internet, the subject invention generates and uses a data hash to identify and authenticate a user attempting to access a restricted resource. The subject invention on demand captures certain web session identification data from a website or page on the Internet, through an application on the user's computer, tablet computer, mobile computing device, web browser, or other computing device. In this instance, the subject invention, on a user's registered mobile device, then dynamically generates a data hash, the “user data hash,” using the user device algorithm and all or parts of one or more public/private key pairs, which the system regularly and dynamically generates on the user device, and which are not transmitted from the user device at any time. The subject invention then encrypts the user data hash using the public key from a different public/private key pair and transmits the encrypted user data hash on the Internet to the central server. The subject invention installed on that server then (i) decrypts the user data hash using the relevant private key; (ii) independently generates a second data hash, the “server data hash,” using the server algorithm and all or parts of one or more public/private key pairs that the system regularly and dynamically generates on the central server, and which are not transmitted from the central server at any time, and that are different from the public/private key pairs that are regularly and dynamically generated on the subject user device. The server data hash and the user data hash are then compared and if certain criteria are not met, the user is rejected and the central server transmits that result to the website operator, who then denies access to the subject user. If certain comparison criteria are met, the central server confirms the identification and authentication of the subject user, selects the appropriate user ID code from a stored table, and transmits the code to the website operator. The website operator then provides appropriate access to the restricted resource to the subject user. All communications between the user, central server, and the website operator are encrypted. All communications between the central server and the website operator are through a secure server-to-server connection, not over the public Internet. The central server may be hosted by the website operator or a third party.

Since no data hash generated by the subject invention contains sensitive, valuable, or re-usable information, even if a data hash is intercepted during transmission or subsequently, there is no risk of unauthorized use of the user's personal data or identity, or of any disclosure of any personally identifiable or valuable information. Further, since there are no stored credentials (such as usernames and passwords), the system eliminates the need for the user to remember and input website specific usernames and passwords and also eliminates the costly burden of maintaining and safeguarding highly vulnerable password databases for commercial participants.

In another embodiment, a commercial participant can use the present invention for identification and authentication when establishing a new relationship with a previously unknown user. In this case, the originating commercial participant would use the system to transmit certain identifying information concerning the applicant, including for example without limitation, name and address, or name and last four digits of a social security number, to a central server, which would either (i) compare the received data to a central database of known users; or (ii) forward the received data to a limited network of commercial participants who use the system, each of which maintains its own database of users. If the subject applicant is a registered user of the system with any of the commercial participants in the network, then the system installed with that commercial participant would send a standard push notification to the subject applicant. The subject applicant would then open the system on his or her registered computing device, and using the system, confirm or deny that he or she is in fact making the subject application. If the applicant confirms the application, the system would then identify and authenticate the user as described in the previous embodiment and communicate the result to the originating commercial participant, specifically (i) the user device would generate a hash, encrypt and transmit it to the central server; (ii) the central server would decrypt the hash and then independently generate a new hash without reference to the original hash and using data inputs and an algorithm different from those used to generate the user data hash, and; (iii) the central server would then compare the two hashes to confirm or deny authentication and transmit the decision to the original commercial participant.

In another embodiment, the system can be used to provide strong customer authentication (SCA) of a transaction on the Internet, where strong customer authentication is an industry standard term referring to additional security measures for certain online transactions. In this case, a user would have already used the system to log into a restricted resource and would initiate a transaction that requires further customer approval, such as for example without limitation, a transfer from a financial account or a stock share purchase or sale. In this case, since the user is already logged in, the commercial participant's system would send a standard push notification to the user asking him or her to approve or reject the transaction. If the user rejects the transaction, then the commercial participant's system would reject the transaction. If the user approves the transaction, then the system would authenticate the user as described earlier, specifically, (i) the user device would generate a hash, encrypt and transmit it to the central server; (ii) the central server would decrypt the hash and then independently generate a new hash without reference to the original hash and using data inputs and an algorithm different from those used to generate the user data hash, and; (iii) the central server would then compare the two hashes to confirm or deny authentication and transmit the decision to the original commercial participant.

In some embodiments, when a subject user gains access to a restricted resource or makes a transaction, the system server sends a push notification to other registered devices associated with the subject user account. Such push notification might use industry standard technology, including for example without limitation, from the Google or Apple. Upon receiving such notification, the user may use the system to terminate the attempted access if the access is not authorized by the user.

### BRIEF DESCRIPTION OF THE DRAWINGS

FIG. 1 shows a diagram of the system process for user identification and authentication for accessing a restricted resource in accordance with an embodiment of the subject invention.

FIG. 2 shows a diagram of the system process for user identification and authentication during user onboarding in accordance with an embodiment of the subject invention.

FIG. 3 shows a diagram of the system process for user identification and authentication for a strong customer authentication of a transaction in accordance with an embodiment of the subject invention.

### DETAILED DESCRIPTION OF EXEMPLARY EMBODIMENTS

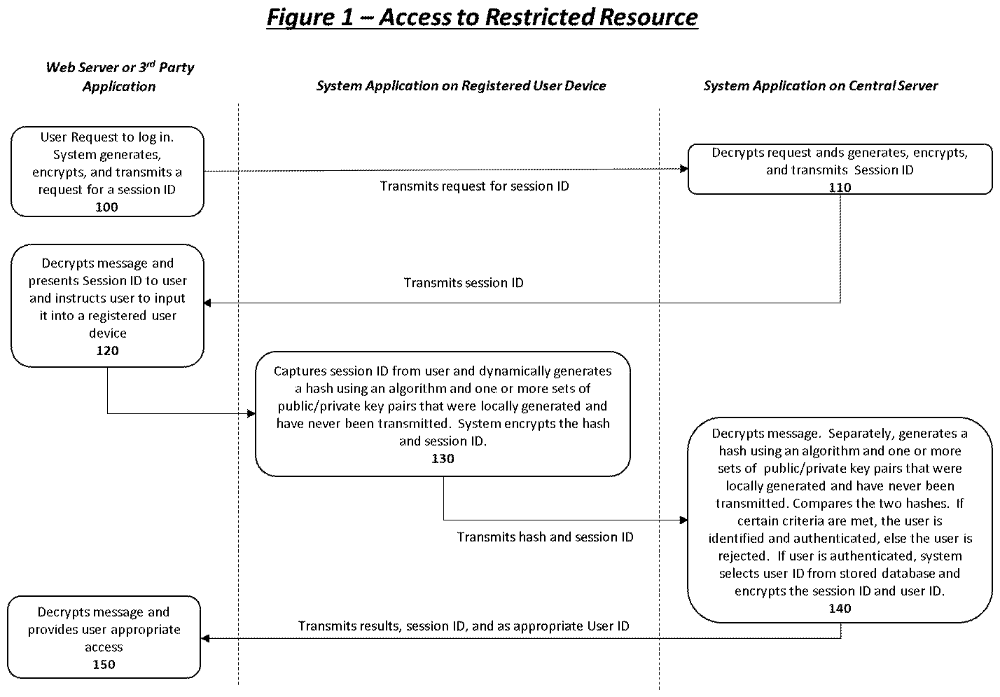

As seen in FIGS. 1, 2, and 3, the subject invention comprises a system and method to identify and authenticate users in various transactions on the Internet, a computer network, phone, through a call center, via email, or in person.

As seen in FIG. 1, where a subject user is attempting to log into a restricted resource, the system process starts with a user request to log into the restricted resource 100. This request prompts the system installed on the web server to generate, encrypt, and transmit a request for a session ID to the system central server. The system application on the central server decrypts the submitted message and generates, encrypts, and transmits a session ID 110, to the web server. These communications, and all communications between the web server and the central server, are completed using a secure server-to-server connection and not over the public Internet. The web server decrypts the session ID, presents it to the user and instructs the user to input it into a user device registered with the system 120. The session ID may be captured by the system on the registered user device in multiple ways, including without limitation the user entering the session ID code or by the user scanning a presented QR Code or other code.

The system on the registered user device captures and decrypts the session ID. The system then generates the user data hash, using the user device algorithm and all or parts of one or more public/private key pairs that were system generated on the user's device and which have never been transmitted. The system encrypts the user data hash and session ID and transmits both to the system on the central server, 130. As noted previously, the user data hash contains no sensitive, previously stored, or re-usable data or information. Further, it does not contain any information stored on the central server or on the user device. It is simply a fixed length alpha numeric character string, for example without limitation 2048 bits, generated by the user device algorithm using the noted data inputs and it cannot be broken down or “reverse-engineered” to reveal its original data inputs. The public/private key pairs that are used in generating the user data hash are regularly generated, replaced, and discarded by the system on a timetable set by the system, for example without limitation, every two to three minutes. The key pairs are never transmitted or disclosed to another server or resource.

On the central server, the system decrypts the transmission. Then, separately and without reference to the user data hash or session ID, the system generates the server data hash using the server algorithm and all or parts of one or more public/private key pairs that were system generated on the central server and which have never been transmitted. The system then compares the user data hash and the server data hash. If certain criteria are met, the user is identified and authenticated, else the user is rejected. If user is authenticated, the system selects the relevant user ID from a stored database and encrypts and transmits the session ID and user ID to the web server over a secure point-to-point connection, not over the public Internet, 140. The public/private key pairs that are used in generating the server data hash are regularly generated, replaced, and discarded by the system on a timetable set by the system, for example without limitation, every two to three minutes. The key pairs are never transmitted or disclosed to another server or resource. It should be noted that the key pairs used to generate the user data hash are different from those used to generate the server data hash. Further, the user device algorithm and the server algorithm are also different from each other. The central server does not compare the user data hash to any previously stored data or information for purposes of user identification or authentication. The central server and registered user device do not store any common data used by the system for purposes of user identification or authentication.

The web site operator decrypts the message and provides the user with the appropriate access, 150.

In sharp contrast to the prior art, central server does not compare the user submission to previously stored data or information that is known to be related to the subject user prior to the subject transmission. Further, a valid user data hash of the subject invention can be generated only by a properly registered user device and only during a system process of identification and authentication. The server data hash is generated by the central server only after receipt of the user data hash and without reference to the user submission.

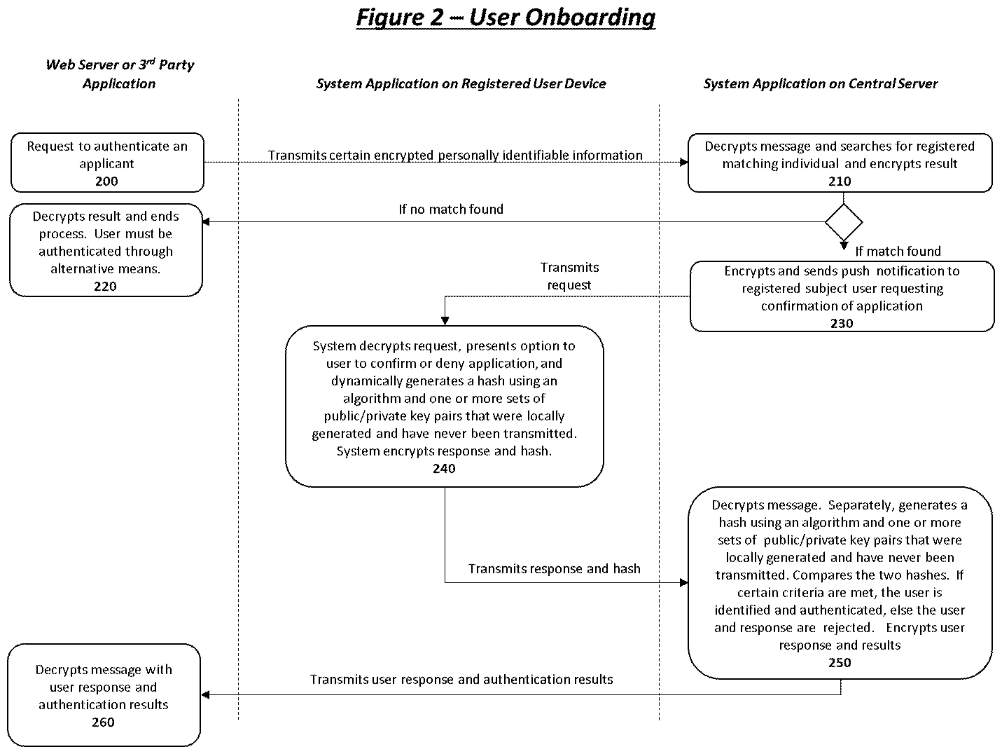

As seen in FIG. 2, in another exemplary embodiment, the system can be used for user onboarding, that is, when a commercial participant and a subject user are first establishing their relationship. The process starts with a web server or third-party application requesting that the system authenticate an applicant by submitting encrypted, agreed upon, limited personally identifiable information about the applicant, including for example without limitation, name and address, or name and last four digits of a social security number 200. The system then determines whether the submitted applicant is currently a registered user of the system with any member of a participating network of commercial participants that use the system. Depending upon the chosen method of implementation, this step might comprise a search of a centrally stored database of all registered users or, alternatively, a query sent to each participating commercial participant to search its own customer base of registered users 210. If no matching user is found, then the system transmits such result to the web site or third-party application and the system process is completed and the applicant must be authenticated through an alternative means 220. If a match is found, the system sends a standard push notification, as described above, to the subject registered user to confirm or deny the subject application 230. Upon receipt of the push notification, the user inputs his or her response to confirm or deny the transaction, and the system on the subject user device generates the user data hash as described in a previous embodiment 240. The user is then identified and authenticated in the manner described in a previous embodiment 250. After successfully authenticating or failing to authenticate the subject user, the system transmits the results to the web server or third-party application 260.

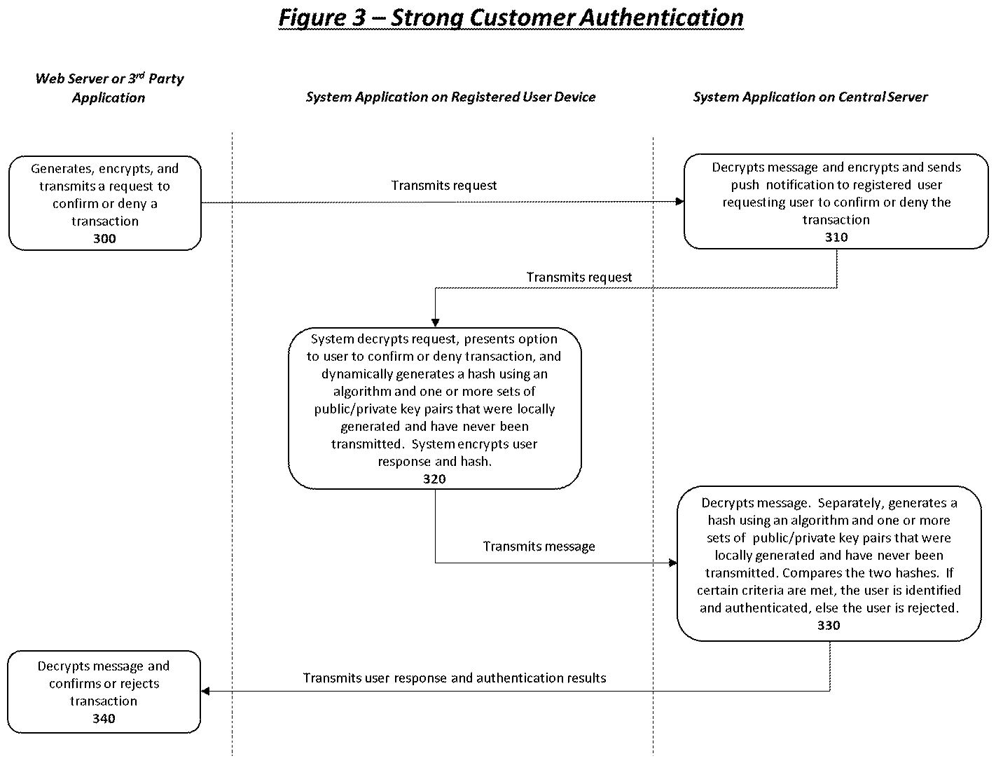

As seen in FIG. 3, in another exemplary embodiment, the system can be used to obtain a strong customer authentication (SCA) from a subject user. During certain online transactions, including for example without limitation, making a purchase or payment, a commercial participant may desire, and in some regulatory situations be required to obtain, an SCA in order to complete a given transaction. The system process starts with a web server generating, encrypting, and transmitting a request for an SCA to the central system server 300. In this example, the subject user would have already used the system to log into the restricted resource in which it is attempting to make a transaction, though this is not required. The central system receives and decrypts the request and sends an industry standard push notification to the user requesting confirmation or denial of the subject transaction 310. The system on the registered user device decrypts the message, presents the request for the SCA confirmation or denial, captures the user response, and generates the user data hash in the manner described in previous embodiments. The system encrypts and transmits the user response and the user data hash to the central server 320. The central system decrypts the transmission determines and authenticates the user identity as in the previous embodiments 330. The web server decrypts the authentication results and confirms or denies the transaction accordingly 340.

The invention claimed is:

1. A computer-based method of determining and authenticating the identity of a user for a transaction in which said identification and authentication are entirely determined by comparing data hashes generated independently and without common inputs by two or more independent computing devices and without comparing any user submission or credential to any previously stored data or information known to be related to the subject user, comprising the steps of:
the system on the subject user device dynamically generates a data hash, that is, a fixed length alpha numeric character string that does not contain, and cannot be manipulated to determine, the original data inputs or algorithm, by applying an algorithm to certain data that were locally generated and stored on the subject user device, have never been transmitted, and are not stored on any other computing device;
the system on the subject user device encrypts the data hash and transmits it to the central server;
the system on the central server decrypts the message and without reference to the data hash submitted by the subject user device, generates a second data hash, that is, a fixed length alpha numeric character string that does not contain, and cannot be manipulated to determine, the original data inputs or algorithm, by applying an algorithm to certain data that were locally generated and stored on the central server, have never been transmitted, and are not stored on any other computing device;
the system on the central server compares the data hash submitted by the subject user device to the data hash generated on the central server;
if the results of said comparison meet certain criteria, the system on the central server identifies and authenticates said user, else said user has failed to be identified and authenticated and is rejected;
if the subject user is identified and authenticated, the system on the central server selects the appropriate user ID from a previously stored database;
the server on the central server encrypts and transmits the appropriate user ID to the appropriate commercial participant.

2. The method of claim 1, wherein the data hash submitted by the subject user device does not contain any sensitive, previously stored, valuable, or re-usable data and cannot be decrypted, broken-down, or manipulated to reveal any sensitive, previously stored, valuable, or re-usable data.

3. The method of claim 1, wherein the data hash generated by the central server does not contain any sensitive, previously stored, valuable, or re-usable data and cannot be decrypted, broken-down, or manipulated to reveal any sensitive, previously stored, valuable, or re-usable data.

4. The method of claim 1, wherein a user is a specific individual person or item, where an item might be for example without limitation, a computer, communications participant or device, device on the internet of things (IoT), or piece of data.

5. The method of claim 1, wherein the certain data used to generate the data hash on the subject user device comprise one or more public/private key pairs that were locally generated, never transmitted, and not stored on any other computing device.

6. The method of claim 1, wherein the certain data used to generate the data hash on the central server comprise one or more public/private key pairs that were locally generated, never transmitted, and not stored on any other computing device.

7. The method of claim 1, wherein a transaction is (i) accessing a restricted resource, including for example without limitation, the logging into a website or private network, (ii) a purchase, payment, or other financial transaction, (iii) an electronic communications exchange, including without limitation email or audio transmission, (iv) new user onboarding (that is, the initial user identification and authentication), (v) user re-onboarding (that is, user identification and authentication wherein a previous authenticated identification has been invalidated for some reason), (v) strong customer authentication (that is, situations wherein an authenticated user must confirm a given transaction for security or regulatory reasons), or (vi) any other transaction wherein identity authentication is desired or required, where such transaction is on the Internet, a computer network, phone, through a call center, via email, or in person.

8. The method of claim 1, wherein the user device is a personal computer, a smart phone, tablet computer, a mobile computer, or other computing device.

9. The method of claim 1, wherein the subject invention delivers multiple factor authentication of the subject user by using multiple electronic channels to send and receive data during the system process.

10. The method of claim 1, wherein the system process identifies and authenticates the subject user, the web or application server associated to the commercial participant involved in the process, and the central server.

11. The method of claim 1, wherein the subject transaction relates to a previously existing relationship between the subject user and the commercial participant.

12. The method of claim 1, wherein the subject transaction does not relate to a previously existing relationship between the subject user and the commercial participant.

13. The method of claim 1, wherein the user and user device have been previously registered with the system on the central server.

14. The method of claim 13, wherein multiple user devices have been previously registered by the subject user with the system on the central server.

15. The method of claim 14, wherein the system on the central server, as an element of the identification and authentication process, sends a push notification to all other user devices registered to the subject user alerting the subject user of an attempted transaction.

16. The method of claim 15, wherein, where said notification enables the subject user to terminate any unauthorized transaction.
